(19) United States
(12) Patent Application Publication
(10) Pub. No.: US 2018/0039212 A1
(43) Pub. Date: Feb. 8, 2018

(54) IMAGE FORMING APPARATUS

(71) Applicant: CANON KABUSHIKI KAISHA, Tokyo (JP)

(72) Inventor: Jun Tomine, Abiko-shi (JP)

(21) Appl. No.: 15/661,574

(22) Filed: Jul. 27, 2017

(30) Foreign Application Priority Data
Aug. 2, 2016 (JP) 2016-152177

(51) Int. Cl. G03G 15/16

(52) U.S. Cl. CPC G03G 15/5054; G03G 21/0005

(57) ABSTRACT

The present disclosure provides an image forming apparatus arranged to be able to reduce sticking of toner on an image bearing member in a configuration in which a part of image bearing members can be separated from an intermediate transfer member. A control portion of the image forming apparatus is configured to execute a first mode to form an image on a recording medium with the first and second image bearing members and a second mode to form an image on a recording medium with the first image bearing member while the second image bearing member being separate from the intermediate transfer member. The control portion execute a rotation process of rotating the second image bearing member temporarily in a duration of the second mode in a case where a detection result of a temperature exceeds a predetermined temperature in the duration of the second mode.

### BACKGROUND OF THE INVENTION

### Field of the Invention

The present invention relates to an electrophotographic image forming apparatus for forming an image on a recording medium.

### Description of the Related Art

There is a known electrophotographic image forming apparatus of a so-called intermediate transfer type tandem configuration. Within the image forming apparatus of this sort, a plurality of photoconductors corresponding to colors of toners are disposed, and toner images formed on the respective photoconductors are primarily transferred onto an intermediate transfer member and are transferred secondarily from the intermediate transfer member to a recording medium to form an image thereon.

Japanese Patent Laid-open No. 2003-043770 discloses a printer configured to bring the respective photoconductors into contact with the intermediate transfer belt in a mode of forming a full-color image, while separating color photoconductors from the intermediate transfer belt in a mode of forming black monochrome image. Because the color photoconductors are not in contact with the intermediate transfer belt in the latter mode, deterioration otherwise caused by abrasion or contact pressure between the both members is reduced.

However, there has been a case where toner and other substances are firmly stuck on a surface of the photoconductors separated from the intermediate transfer member in such configuration in which a part of the photoconductors can be separated from the intermediate transfer belt like the printer in the above-described document. Then, due to such sticking of toner, there has been a case where a striped defective image is generated when the printer outputs a full-color image.

### SUMMARY OF THE INVENTION

Accordingly, the present disclosure provides an image forming apparatus arranged to be able to reduce caking of toner and others on an image bearing member in a configuration in which a part of image bearing members can be separated from an intermediate transfer member.

According to one aspect of the present invention, an image forming apparatus includes a first image bearing member configured to rotate while bearing a toner image, a second image bearing member configured to rotate while bearing a toner image, an endless intermediate transfer member configured to bear and convey a toner image transferred from either or both of the first and second image bearing members and to be transferred to a recording medium at a transfer portion, a switch mechanism configured to switch between a state in which the second image bearing member is in contact with the intermediate transfer member and a state in which the second image bearing member is separated from the intermediate transfer member, a cleaning member disposed in contact with the second image bearing member and configured to clean a surface of the second image bearing member along with rotation of the second image bearing member, a temperature detecting portion configured to detect temperature, and a control portion configured to execute an either mode of a first mode and a second mode, the first mode being a mode in which toner images are formed on the first and second image bearing members and are transferred to the intermediate transfer member so as to form an image on the recording medium in a state where the first and second image bearing members are in contact with the intermediate transfer member, the second mode being a mode in which a toner image is formed on the first image bearing member and is transferred to the intermediate transfer member so as to form an image on the recording medium in a state where the first image bearing member is in contact with the intermediate transfer member and the second image bearing member is separated from the intermediate transfer member, the control portion being configured to execute a rotation process in which rotation of the second image bearing member being in a stopped condition is started and then is stopped in a duration of the second mode in a case where detection result of the temperature detecting portion exceeds a predetermined temperature in the duration of the second mode.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus of the present disclosure.

FIG. 2 is a schematic diagram illustrating a configuration of an image forming portion.

FIG. 3A is a section view illustrating an all-contact condition in which all photosensitive drums of the respective image forming portion are in contact with an intermediate transfer belt.

FIG. 3B is a section view illustrating a partial contact condition in which a part of the photosensitive drums are separated from the intermediate transfer belt.

FIG. 3C is a section view illustrating an all-separation condition in which all of the photosensitive drums are separated from the intermediate transfer belt.

FIG. 4 is a section view illustrating a moving mechanism of a primary transfer roller.

FIG. 5 is a perspective view of a cam composing the moving mechanism.

FIG. 6A is a plan view illustrating a shape of a holder of the primary transfer roller.

FIG. 6B is a plan view of another shape of the holder of the primary transfer roller.

FIG. 7A is a section view illustrating a main part of the moving mechanism in a color mode.

FIG. 7B is a section view illustrating the main part of the moving mechanism in a monochrome mode.

FIG. 7C is a section view illustrating the main part of the moving mechanism in the all-separation condition.

FIG. 8A is a plan view illustrating the main part of the moving mechanism in the color mode.

FIG. 8B is a plan view illustrating the main part of the moving mechanism in the monochrome mode.

FIG. 8C is a plan view illustrating the main part of the moving mechanism in the all-separation condition.

FIG. 9 is a block diagram illustrating a control system of the image forming apparatus.

FIG. 10 is a flowchart illustrating a control process of the image forming apparatus of a first embodiment.

FIG. 11 is a graph indicating a relationship between a number of consecutively printed sheets and temperature within the apparatus in the monochrome mode.

FIG. 12 is a flowchart illustrating a control process of the image forming apparatus of a second embodiment.

FIG. 13 is a flowchart illustrating a control process of the image forming apparatus of a third embodiment.

FIG. 14 is a flowchart illustrating a comparative control process of the image forming apparatus.

### DESCRIPTION OF THE EMBODIMENTS

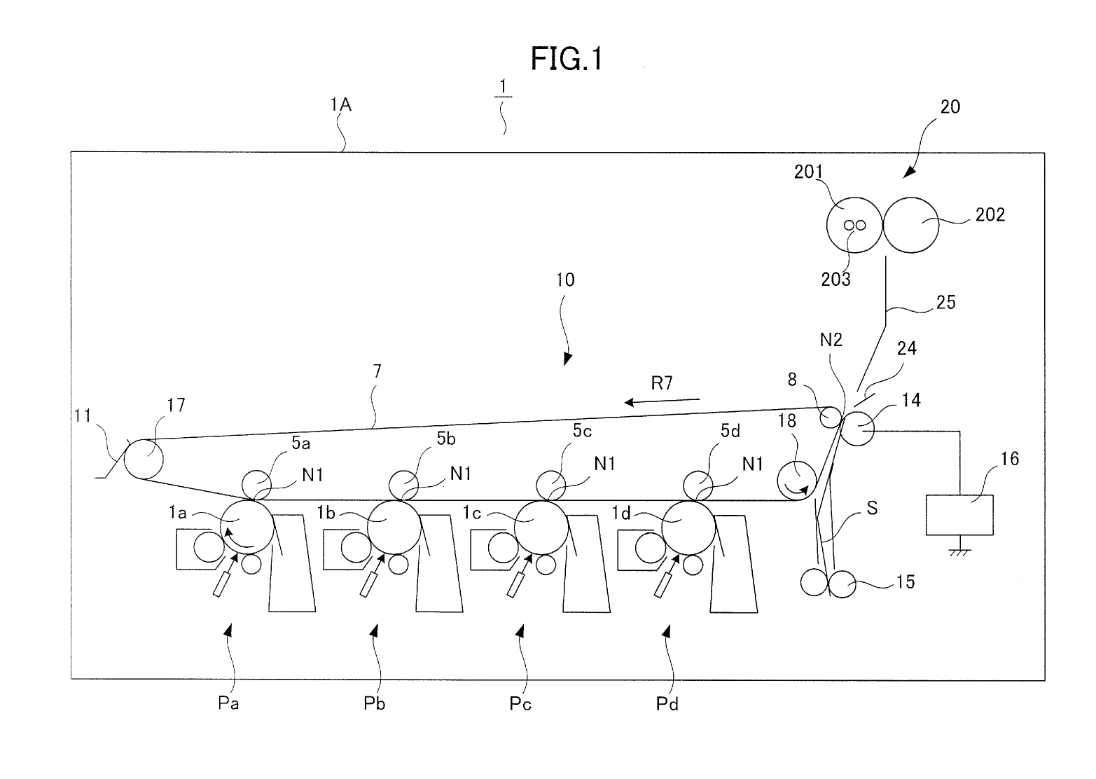

An image forming apparatus of the present disclosure will be described with reference to the drawings. As illustrated in FIG. 1, the image forming apparatus 1 of the present disclosure includes an image forming portion 10 of a so-called intermediate transfer type tandem configuration, which includes four image forming units Pa, Pb, Pc, and Pd provided within an apparatus body 1A. The image forming apparatus 1 is configured to output and form an image on a recording medium S based on image information read from a document or on image information inputted from an external device. It is noted that the recording medium S refers to, besides a plain paper, those including a special paper such as a coated paper, those having a special shape such as an envelope and an index paper, and those including a plastic film for an overhead projector and a cloth.

The image forming units Pa, Pb, Pc, and Pd are configured to form toner images of yellow (Y), magenta (M), cyan (C) and black (K), respectively. Because configurations of the respective image forming units are basically the same other than that colors of toners used in development are different, the following description will be explained by exemplifying the configuration of the yellow image forming unit Pa.

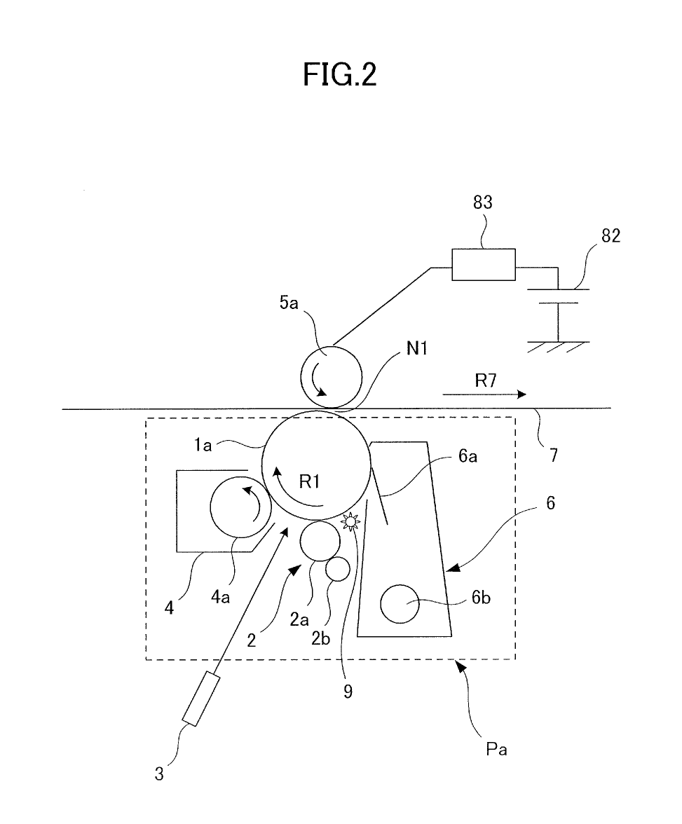

As illustrated in FIG. 2, the image forming unit Pa includes a photosensitive drum 1a, a charging device 2, a developing unit 4, and a cleaning unit 6. The apparatus body 1A also includes an exposure unit 3 configured to scan the photosensitive drum 1a based on the image information. In response to a start of an image forming process, the photosensitive drum 1a is driven to rotate as indicated by an arrow R1 with a predetermined processing speed, e.g., 100 mm/sec of circumferential speed. The surface of the photosensitive drum 1a is homogeneously electrified by proximity discharging of the charging device 2 including a charging roller 2a and charging cleaner 2b, and then an electrostatic latent image is formed on the surface of the photosensitive drum 1a by the exposure unit 13. The electrostatic latent image formed on the photosensitive drum 1a is visualized, i.e., developed, as a toner image by the toner supplied from a developer bearing member 4a of the developing unit 4.

The toner image borne on the photosensitive drum 1a is primarily transferred onto an intermediate transfer belt 7 serving as an intermediate transfer member at a primary transfer portion N1 formed between a primary transfer roller 5a serving as a transfer member and the photosensitive drum 1a. At this time, toner particles of the toner image are adsorbed to the intermediate transfer belt 7 by a bias voltage, i.e., a primary transfer bias, applied to the primary transfer roller 5a from a primary transfer power source 82 through a voltage regulating portion 83. Transfer residual toner left on the photosensitive drum 1a is collected by the cleaning unit 6 having a cleaning blade 6a and a collecting screw 6b.

Toner images of the respective colors are formed similarly also on the photosensitive drums in the image forming units Pb, Pc, and Pd. The toner images formed on the respective photosensitive drums are primarily transferred onto the intermediate transfer belt 7 so as to be superimposed with each other by primary transfer rollers 5b through 5d disposed on an inner circumferential side of the intermediate transfer belt 7.

As illustrated in FIG. 1, the intermediate transfer belt 7 is an endless belt member wound around a secondary transfer inner roller 8, a tension roller 17 and a driven roller 18. The intermediate transfer belt 7 is driven by the secondary transfer inner roller 8, which serves as a driving roller, to rotate in a direction of an arrow R7 along rotation of the photosensitive drums 1a through 1d in a condition in which an adequate tension is applied to the intermediate transfer belt 7 by the tension roller 17.

A secondary transfer roller 14 is disposed downstream of the image forming units Pa through Pd in the rotation direction of the intermediate transfer belt 7 so as to face the secondary transfer inner roller 8 across the intermediate transfer belt 7. A bias voltage serving as a secondary transfer bias is applied to the secondary transfer roller 14 from a secondary transfer power source 16 through a voltage regulating portion not illustrated. Thereby, the toner image borne on the intermediate transfer belt 7 are transferred collectively onto the recording medium S at a secondary transfer portion N2 formed between the secondary transfer roller 14 and the secondary transfer inner roller 8. Adhesive materials such as transfer residual toner left on the intermediate transfer belt 7 after passing through the secondary transfer portion N2 are removed by a belt cleaning device 11.

It is noted that the present embodiment adopts a reverse developing system, and the bias voltage applied in the abovementioned configuration is set in accordance to the system. That is, the charging bias voltage having the same polarity as that of the electrified toner, i.e., negative polarity, is applied to the charging roller 2a to electrify the photosensitive drums 1a through 1d with negative polarity. The charging bias voltage may be negative DC voltage alone, or DC voltage superimposed with AC voltage may be also used. The bias voltage having polarity inverse to that of the electrified toner, i.e., positive polarity, is applied to the primary transfer rollers 5a through 5d and the secondary transfer roller 14 to electrostatically attract the toner particles at the primary and secondary transfer portions N1 and N2.

In parallel with such image forming process, a sheet feed portion provided in the apparatus body 1A executes an operation of feeding the recording medium S toward the image forming portion 10. The sheet feed portion includes sheet feed cassettes and feed units provided for each sheet feed cassette. The feed unit may be a retard roller type or a separation pad type and is configured to feed the recording medium S stacked on the sheet feed cassette while separating one by one. The recording medium S fed by the sheet feed portion is delivered to a registration roller pair 15 disposed right before the secondary transfer portion N2. The registration roller pair 15 corrects a skew of the recording medium S and also conveys the recording medium S to the secondary transfer portion N2 while synchronizing with the advance of the image forming process in the image forming portion 10.

The recording medium S on which the non-fixed toner image has been transferred at the secondary transfer portion N2 is passed to the fixing device 20 while being guided by guide members 24 and 25. The fixing device 20 is composed of a heating roller 201 serving as a fixing roller, which is heated by a heat source 203 such as a halogen heater, and a counter roller 202 serving as a pressure roller in pressure contact with the heating roller 201. Then, the recording medium S is nipped at a fixing nip between the heating roller 201 and the counter roller 202 and is heated and pressurized so as to melt the toner and to fix the image onto the recording medium S.

Then, the recording medium S on which the toner image has been fixed by the fixing device 20 is passed to a discharge roller pair not shown to be discharged out to a discharge tray. In a case where duplex printing is to be carried out, the recording medium S is guided toward a reverse conveyance portion at a branch conveyance portion provided between the fixing device 20 and the discharge roller pair and is passed to a duplex conveyance portion in a condition in which a first surface, i.e., a front surface, is reversed to a second surface, i.e., a back surface, by the reverse conveyance portion. Then, the recording medium S is conveyed to the registration roller pair 15 by the duplex conveyance portion, and an image is transferred again to the back surface of the recording medium S at the secondary transfer portion N2. Then, the recording medium S is fixed at the fixing device 20 and is then discharged to the discharge tray.

The operation of the image forming apparatus 1 outputting a color image has been described in the abovementioned description, and the image forming apparatus 1 can also execute an operation of outputting a monochrome image by using the black image forming unit Pd. That is, the image forming apparatus 1 can execute an image forming operation of a color mode in which the image forming apparatus 1 outputs a full-color image by using the four image forming units Pa, Pb, Pc, and Pd, and an image forming operation of a monochrome mode in which the image forming apparatus 1 outputs a black monochrome image by using only the black image forming unit Pd.

### Switching of Contact Condition of Intermediate Transfer Belt

Next, an operation for switching contact conditions between the photosensitive drums 1a through 1d of the image forming units Pa, Pb, Pc, and Pd and the intermediate transfer belt 7 in accordance with the modes of the image forming operation will be described.

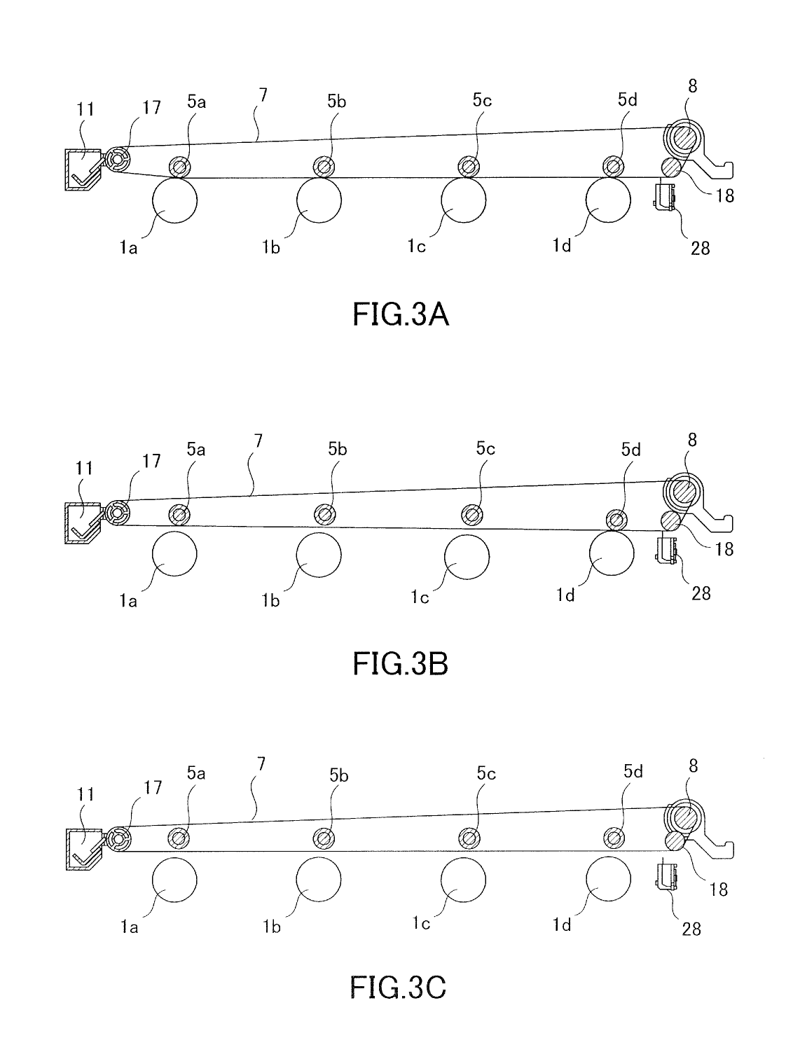

As illustrated in FIG. 3A, the image forming operation is executed in a condition in which the respective photosensitive drums 1a through 1d are in contact with the intermediate transfer belt 7, i.e., in an all-contact condition, in the color mode. In this case, the respective photosensitive drums 1a through 1d rotate with the intermediate transfer belt 7, and toner images are formed in parallel by the four image forming units Pa through Pd.

Meanwhile, as illustrated in FIG. 3B, the image forming operation is executed in a condition in which the black photosensitive drum 1d is in contact with the intermediate transfer belt 7 and the color photosensitive drums 1a, 1b and 1c are separated from the intermediate transfer belt 7, i.e., in a partial contact condition, in the monochrome mode. In this case, while the photosensitive drum 1d rotates with the intermediate transfer belt 7 and a toner image is formed by the image forming unit Pd, the photosensitive drums 1a, 1b and 1c are stopped to rotate. During execution of the monochrome mode, the photosensitive drums 1a, 1b and 1c are separated from the intermediate transfer belt 7 to reduce wear otherwise caused by friction and deterioration otherwise caused by contact pressure of the both members.

The color mode corresponds to a first mode in the image forming operation and the monochrome mode corresponds to a second mode. The black photosensitive drum 1d corresponds to a first image bearing member that is in contact with the intermediate transfer member commonly in the first and second modes. Each color photosensitive drums 1a, 1b and 1c corresponds to a second image bearing member in contact with the intermediate transfer member in the first mode and separated from the intermediate transfer member in the second mode.

It is noted that as illustrated in FIG. 3C, the image forming apparatus 1 is able to switch to a condition in which all of the photosensitive drums 1a through 1d are separated from the intermediate transfer belt 7, i.e., in an all-separation condition. It is preferable to adopt this condition in replacing the intermediate transfer belt 7 for example because the intermediate transfer belt 7 is released from the photosensitive drums 1a through 1d. Still further, there is a case where a patch density sensor 28 capable of detecting density of a toner patch formed by the respective image forming units Pa through Pd is disposed between the most downstream photosensitive drum 1d and the secondary transfer inner roller 8. In this case, it is preferable to separate the intermediate transfer belt 7 from the patch density sensor 28 by simultaneously moving the driven roller 18 in the all-separation condition.

### Moving Mechanism of Primary Transfer Roller

Next, a switch mechanism for switching contact condition between the photosensitive drums 1a through 1d and the intermediate transfer belt 7 will be described. As illustrated in FIGS. 3A through 3C, the respective primary transfer rollers 5a through 5d are movable between contact positions where the respective primary transfer rollers 5a through 5d come into contact with the corresponding photosensitive drums 1a through 1d across the intermediate transfer belt 7 and separate positions where the respective primary transfer rollers 5a through 5d are separated from the corresponding photosensitive drums 1a through 1d. That is, the intermediate transfer belt 7 is brought into contact with and is separated from the photosensitive drums 1a through 1d by movement of the primary transfer rollers 5a through 5d.

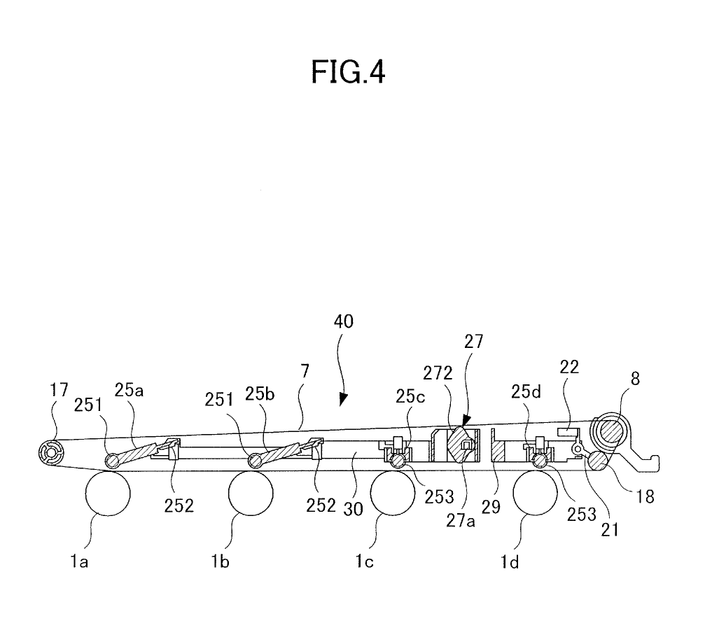

As illustrated in FIG. 4, the moving mechanism 40 of the primary transfer rollers 5a through 5d includes slide members 29 and 30 movable in a horizontal direction with respect to the apparatus body and a cam member 27 configured to move the slider members. The slider members include a black slider (Bk slider, hereinafter) 29 configured to move the black primary transfer roller 5d and a color slider (CL slider, hereinafter) 30 configured to move the primary transfer rollers 5a, 5b and 5c of yellow, magenta and cyan. The Bk slider 29 and the CL slider 30 are provided separately. The Bk slider 29 corresponds to a first actuation portion configured to move the first transfer member, and the CL slider 30 corresponds to a second actuation portion configured to move the second transfer member. The cam member 27 engages with the Bk slider 29 and the CL slider 30, respectively, in a condition in which the cam member 27 is supported by a cam shaft 27a connected with a cam driving motor not illustrated.

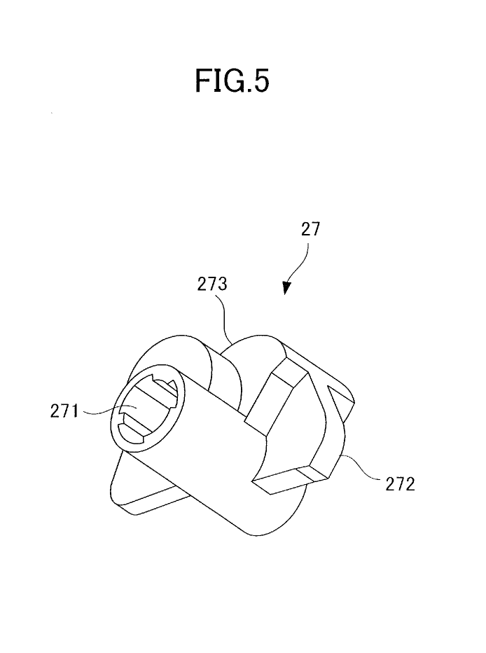

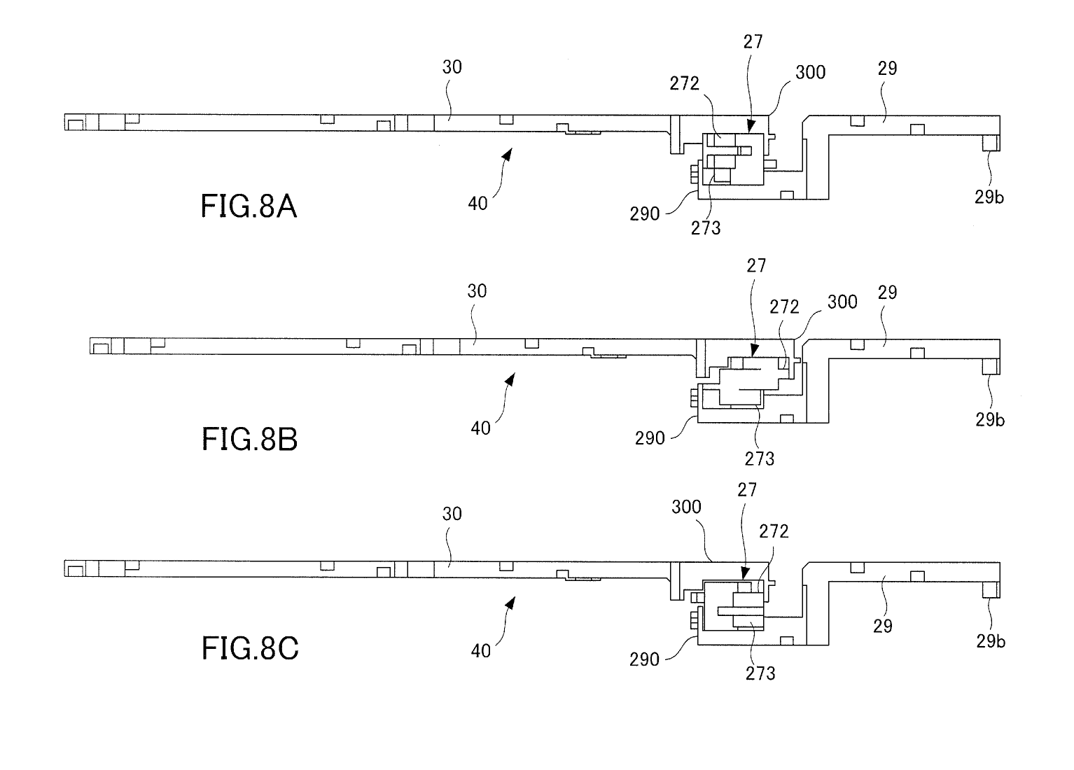

As illustrated in FIG. 5, the cam member 27 includes a boss portion 271 configured to engage with the cam shaft 27a so as not to rotate relatively, a first cam surface 272 configured to engage with an engage portion 290 of the Bk slider 29 and a second cam surface 273 configured to engage with an engage portion 300 of the CL slider 30 (see also FIG. 8). The cam member 27 is configured such that the first and second cam surfaces 272 and 273 have different shapes from each other when viewed from an axial direction of the cam shaft 27a and such that the Bk slider and the CL slider 30 can be moved separately by controlling rotation angle of the cam shaft 27a. In a case of an example illustrated in FIG. 5, the cam member 27 is set such that at least one of the Bk slider 29 and the CL slider 30 moves every time when the cam member 27 is rotated by 120 degrees.

As illustrated in FIG. 4, the Bk slider 29 and the CL slider 30 are connected with roller holders 25a, 25b, 25c and 25d configured to hold the respective primary transfer rollers 5a through 5d. Among the roller holders 25a, 25b, 25c and 25d, the yellow and magenta roller holders 25a and 25b are configured to swing along with the move of the slider members.

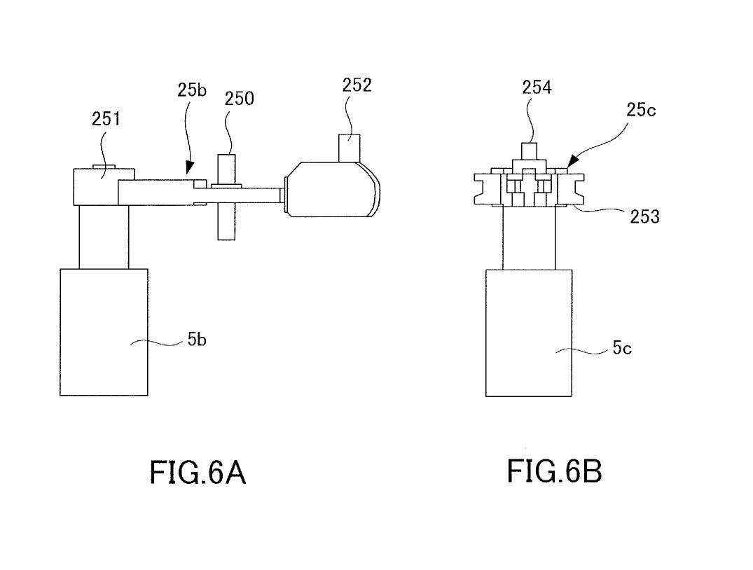

That is, as the roller holder 25b is illustrated in FIG. 6A as a typical example, the roller holders 25a and 25b are swing members, i.e., lever members, swingable centering on a swing shaft 250 supported by the apparatus body. Provided on one side and another side of the swing shaft 250 are a holding portion 251 configured to rotatably hold the primary transfer rollers 5a and 5b and a project portion 252 configured to engage with the CL slider 30. Meanwhile, as illustrated in FIG. 6B, the cyan and black roller holders 25c and 25d have a shape in which a holding portion 253 configured to rotatably hold the primary transfer rollers 5c and 5d and a project portion 254 configured to engage with the Bk/CL slide members 29 and 30 are coaxially disposed.

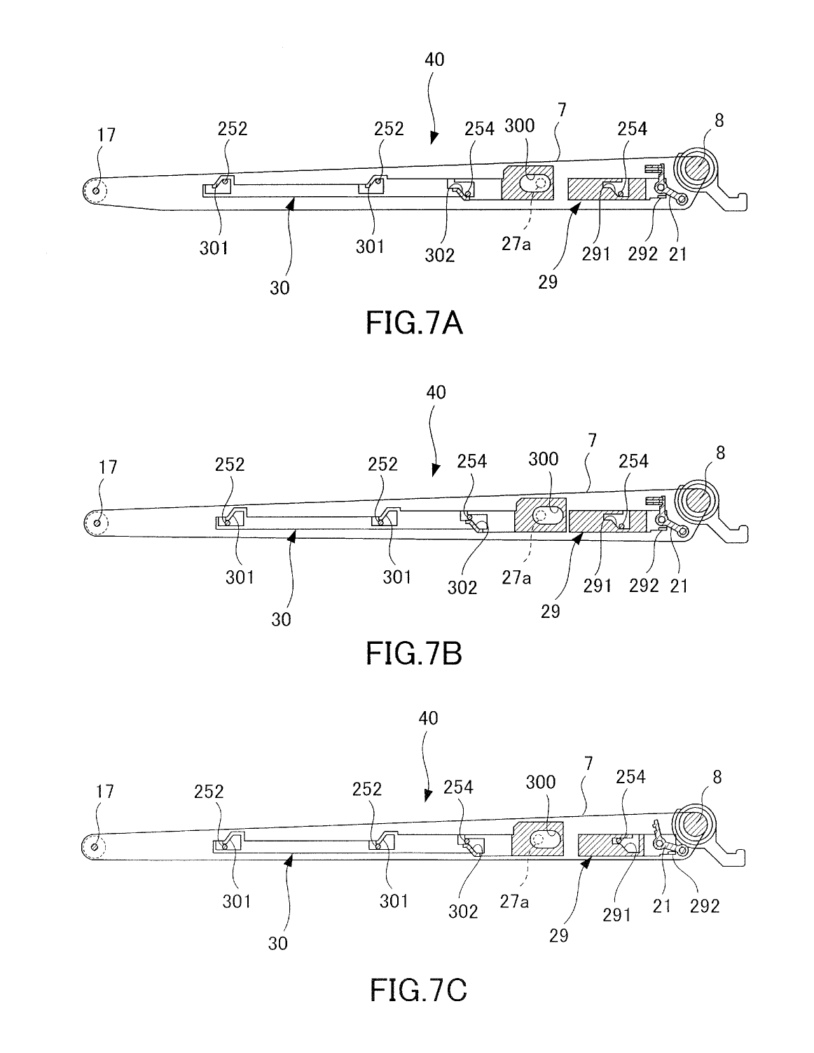

As illustrated in FIG. 7A, the project portions 252 and 254 of the roller holders 25a through 25d are in contact with slope portions 291, 301 and 302 provided in the Bk/CL slide members 29 and 30 and move along the slope when the Bk/CL slide members 29 and 30 moves. Among the slope portions of the CL slider 30, the slope portions 301 corresponding to the yellow and magenta, i.e., the lever type, roller holders 25a and 25b are inclined inversely from that of the slope portion 302 corresponding to the cyan roller holder 25c. Accordingly, the move mechanism is configured such that the color primary transfer rollers 5a, 5b and 5c move in a same direction with respect to the photosensitive drums 1a, 1b and 1c when the CL slider 30 moves in right and left directions in FIG. 7A.

As illustrated in FIGS. 7A through 7C, the BK/CL slide members 29 and 30 are movable between right and left positions, respectively. Here, the right and left positions refer to right and left side positions in FIG. 7A through 7C within a moving ranges of the BK/CL slide members 29 and 30. Depending on setting of an inclination direction of the slope portions 301 and 302, the color primary transfer rollers 5a, 5b and 5c are held at the contact positions when the CL slider 30 is located at the left position, and are held at the separate positions when the CL slider 30 is located at the right position. The black primary transfer roller 5d is held at the contact position when the Bk slider 29 is located at the left position, and is held at the separate position when the Bk slider 29 is located at the right position.

It is noted that the Bk slider 29 is provided with a push-up portion 292 configured to abut with a swing arm 21 holding the driven roller 18 (see also FIG. 4). The swing arm 21 brings the driven roller 18 into pressure contact with an inner circumferential surface of the intermediate transfer belt 7 by a resilient force of a spring member 22 and positions the intermediate transfer belt 7 along a body rail not illustrated. The push-up portion 292 pushes up the swing arm 21 by resisting against urging force of the spring member 22 corresponding to the operation, caused by the slope portion 291, of moving the black primary transfer roller 5d from the contact position to the separate position.

With such arrangement described above, the moving mechanism 40 moves the primary transfer rollers 5a through 5d from the contact position to the separate position corresponding to the modes of the image forming operation. As illustrated in FIGS. 7A and 8A, the CL slider 30 is positioned at the left position and the Bk slider 29 is positioned at the left position by the cam member 27 in the color mode. Then, because all of the primary transfer rollers 5a through 5d are held at the contact positions, the respective photosensitive drums 1a through 1d come into contact with the intermediate transfer belt 7.

As illustrated in FIGS. 7B and 8B, in the monochrome mode, the CL slider 30 is positioned at the right position and the Bk slider 29 is positioned at the left position by the cam member 27. Then, because the color primary transfer rollers 5a, 5b and 5c are held at the separate positions and the black primary transfer roller 5d is held at the contact position, only the black photosensitive drum 1d is in contact with the intermediate transfer belt 7.

As illustrated in FIGS. 7C and 8C, if the CL slider 30 is positioned at the right position and the Bk slider 29 is positioned at the right position by the cam member 27, all of the primary transfer rollers 5a through 5d are held at the separate position. Therefore, an all-separation condition in which the respective photosensitive drums 1a through 1d are separated from the intermediate transfer belt 7 is realized. In this state, the swing arm 21 is pushed up by the push-up portion 292 and the driven roller 18 recedes upward (see also FIG. 3C).

It is noted that positions similar to those in the monochrome mode are set as home positions of the primary transfer rollers 5a through 5d in the present embodiment. That is, only the black primary transfer roller 5d is located at the contact position and the other primary transfer rollers 5a, 5b and 5c are held at the separate position (see FIGS. 7B and 8B) during standby period for a printing job. However, the other positions, e.g., the separate positions of all of the primary transfer rollers 5a through 5d, may be set as home positions.

### Toner Sticking in Monochrome Mode

As described above, in the monochrome mode, the image forming operation is executed by using the black photosensitive drum 1d while the color photosensitive drums 1a, 1b and 1c are separated from the intermediate transfer belt 7. However, in a case where the condition in which the rotation of the photosensitive drums 1a, 1b and 1c is stopped in the monochrome mode continues for a certain period of time, there is a case where adhesive materials including toner are firmly stuck on the surface of the drums. That is, toner and external additives such as wax accumulated in a nip portion between the cleaning blade 6a (see FIG. 2) and the photosensitive drums 1a, 1b and 1c may be pressed against and fixed to the surface of the drums by contact pressure, i.e., nip pressure, of the cleaning blade 6a.

It was confirmed that such toner sticking likely occurs particularly in a case where temperature within the apparatus body increases by conducting consecutive printing, or consecutive feeding, of consecutively forming images on a large number of recording media. Still further, it has been known that as an operation time of the image forming apparatus 1 increases, a drum surface wears due to friction between the photosensitive drum and other members such as the cleaning blade, so that surface roughness of the photosensitive drum changes, increases normally. It is conceivable that chance of occurrence of toner sticking on the drum surface changes due to such factors.

If a printing job of a color image is inputted in the condition in which there is toner stuck on the surface of the photosensitive drums 1a, 1b and 1c due to such factors, a defective image may be created. That is, a striped defective image may appear in the toner images outputted from the color image forming units Pa, Pb and Pc because the image forming operation of such toner image is performed in the condition in which toner sticking has occurred along the contact portion of the cleaning blade 6a.

Here, according to the present embodiment, an operation of temporarily rotating the color photosensitive drums 1a, 1b and 1c is executed in a case where a predetermined condition is met in a duration of the monochrome mode in order to avoid such unfavorable result of toner sticking. A specific exemplary arrangement of the image forming apparatus 1 will be described below along a flowchart executed by a control portion.

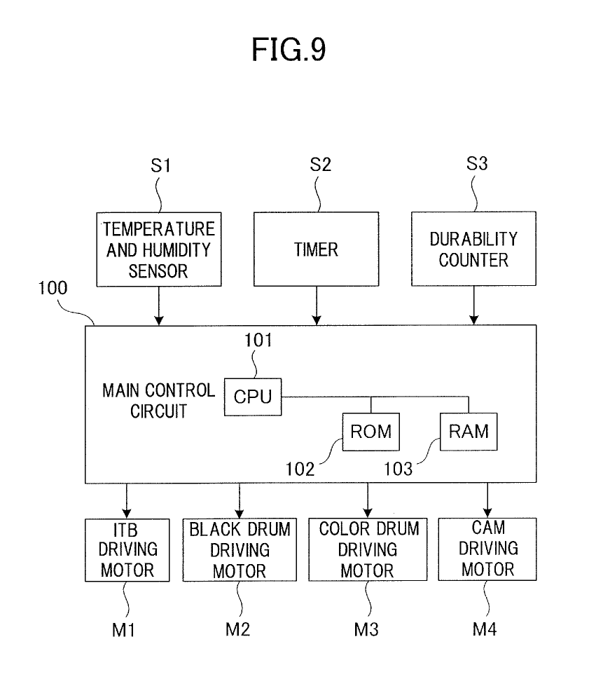

It is noted that the following control process is executed by the control portion including a main control circuit 100 as illustrated in FIG. 9. The main control circuit 100 serving as the control portion integrally controls the image forming apparatus 1 includes a central processing unit (CPU) 101 serving as an execution portion of a control program, a read only memory (ROM) 102 and a random access memory (RAM) 103, which serve as storage portions. The ROM 102 and the RAM 103 temporarily and/or permanently store data such as control programs and setting information for printing jobs.

The main control circuit 100 receives input signals from: a temperature and humidity sensor S1 configured to detect temperature and humidity within the image forming apparatus 1; a timer S2 capable of counting an elapsed time in each step of the control process; and a durability counter S3 configured to record a number of images outputted from the image forming apparatus 1. The temperature and humidity sensor S1 is an exemplary temperature detecting portion capable of detecting temperature change within the apparatus. The timer S2 and the durability counter S3 may be replaced by software systems whose functions are achieved by the CPU 101.

The main control circuit 100 is also capable of controlling driving motors M1 through M4 in accordance with the control process. The ITB (intermediate transfer belt) driving motor M1 drives the secondary transfer inner roller to rotate the intermediate transfer belt 7. The drum driving motors M2 and M3 are provided respectively for the color photosensitive drums 1a, 1b and 1c and the black photosensitive drum 1d and rotate the corresponding photosensitive drums. The cam driving motor M4 rotates the cam member 27 through an intermediary of the cam shaft 27a.

It is noted that the cam driving motor M4 is composed of a stepping motor for example, and the CPU 101 can detect a rotation phase of the cam member 27 from a driving amount of the cam driving motor M4. However, another detection mechanism such as a sensor directly detecting position of the intermediate transfer belt 7 may be disposed as long as it is an arrangement capable of detecting whether the photosensitive drums 1a through 1d are in contact with the intermediate transfer belt 7.

### First Embodiment

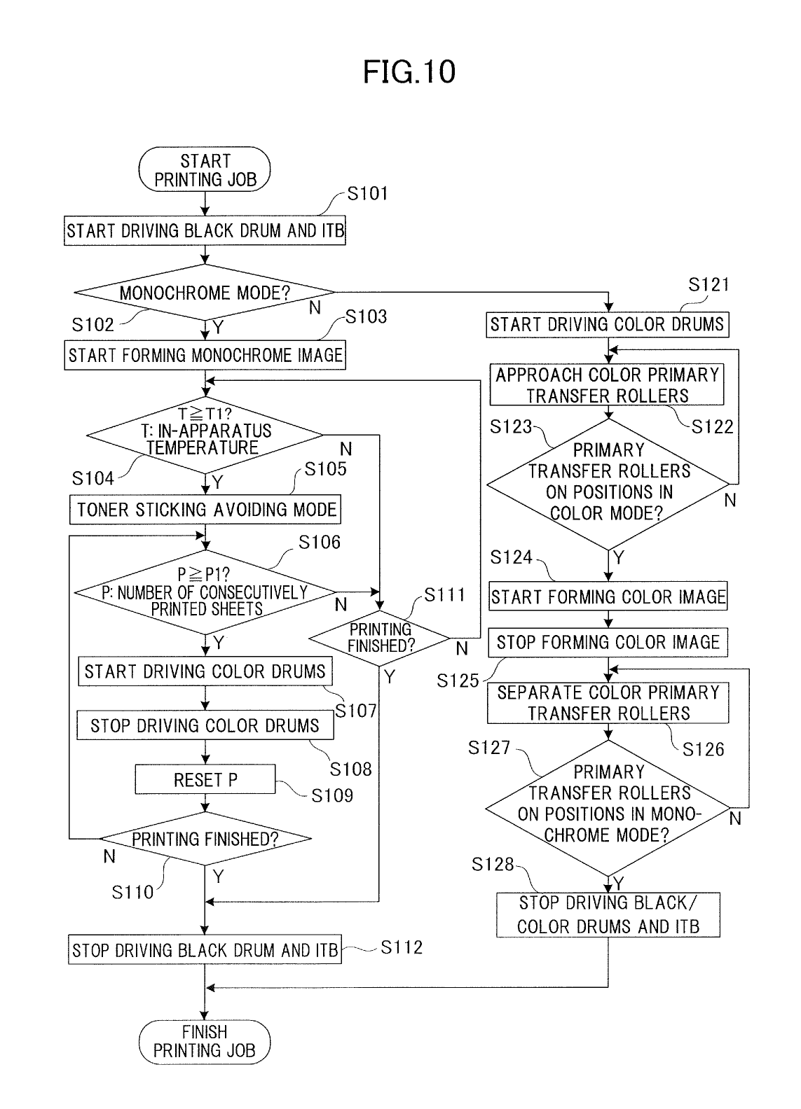

The control process of a first embodiment will be described at first along a flowchart in FIG. 10. In response to an input of a print job to the image forming apparatus 1, the CPU 101 starts rotating the black photosensitive drum 1d and the intermediate transfer belt 7 in Step S101 and determines whether an image to be outputted is a color image or a monochrome image in Step S102.

### Monochrome Mode

The monochrome mode is selected when the monochrome image is to be outputted, i.e., Y in Step S102, and forming a toner image in the black image forming unit Pd is started in Step S103. At this time, the color primary transfer rollers 5a, 5b and 5c are located at the separate position, and the color photosensitive drums 1a, 1b and 1c are stopped their rotation. In the monochrome mode, while monitoring whether temperature within the apparatus detected by the temperature and humidity sensor S1, i.e., in-apparatus temperature T, exceeds a predetermined temperature T1 in Step S104, the CPU 101 continues the printing job in Step S111.

In a case where the in-apparatus temperature T reaches a value equal to or more than the predetermined temperature T1, i.e., Y in Step S104, the CPU 101 shifts the mode to a toner sticking avoiding mode in Step S105 and judges whether a number of consecutively printed sheets P exceeds a predetermined number of sheets P1 in Step S106. Here, the number of consecutively printed sheets P is a number of the recording media S on which images are formed after when the in-apparatus temperature T has reached the predetermined temperature T1 in the monochrome mode. In a case where the number of consecutively printed sheets P is less than the predetermined number of sheets P1, i.e., N in Step S106, the CPU 101 leaves from the toner sticking avoiding mode and continues the normal printing job.

In a case where the number of consecutively printed sheets P is equal to or more than the predetermined number of sheets P1, i.e., Y in Step S106, the CPU 101 executes the process of temporarily rotating the color photosensitive drums 1a, 1b and 1c. That is, after driving the corresponding driving motor M3 for a certain period of time in Step S107, the CPU 101 executes the process of stopping the rotation in Step S108. While the driving time of the driving motor M3 is arbitral, it is preferable to set the driving time to be less than one rotation in terms of a rotation amount of the photosensitive drums 1a, 1b and 1c, e.g., 60 msec, since it is sufficient for avoiding toner sticking. The photosensitive drums 1a, 1b and 1c are driven to rotate while being kept separate from the intermediate transfer belt 7.

In the case where the CPU 101 executes the rotation of the photosensitive drums 1a, 1b and 1c, the CPU 101 resets the value of the number of consecutively printed sheets P in Step S109 and continues the printing job in Step S110. Then, when output of the images of the number of sheets inputted as the printing job has ended, i.e., Y in Step S110 and Y in Step S111, the CPU 101 stops the rotation of the photosensitive drum 1d and the intermediate transfer belt 7 in Step S112 to finish the printing job.

### Color Mode

Meanwhile, in a case where the color image is to be outputted, i.e., N in Step S102, the CPU 101 starts to rotate the color photosensitive drums 1a, 1b and 1c in Step S121 and makes the primary transfer rollers 5a, 5b and 5c approach the corresponding photosensitive drums through the moving mechanism 40 in Step S122. When it is confirmed that the primary transfer rollers 5a, 5b and 5c have reached the contact positions, i.e., Y in Step S123, the respective image forming units Pa, Pb, Pc and Pd start to form toner images in Step S124.

When an output of the number of color image sheets inputted as the printing job is finished in Step S125, the CPU 101 moves the color primary transfer rollers 5a, 5b and 5c toward the separate positions in Step S126. Then, after confirming that the respective primary transfer rollers 5a through 5d are located at their home positions, i.e., Y in Step S127, the CPU 101 stops the rotation of the photosensitive drums 1a through 1d and the intermediate transfer belt 7 in Step S128 to finish the printing job.

### Setting of Threshold Values of Temperature and Number of Consecutively Printed Sheets

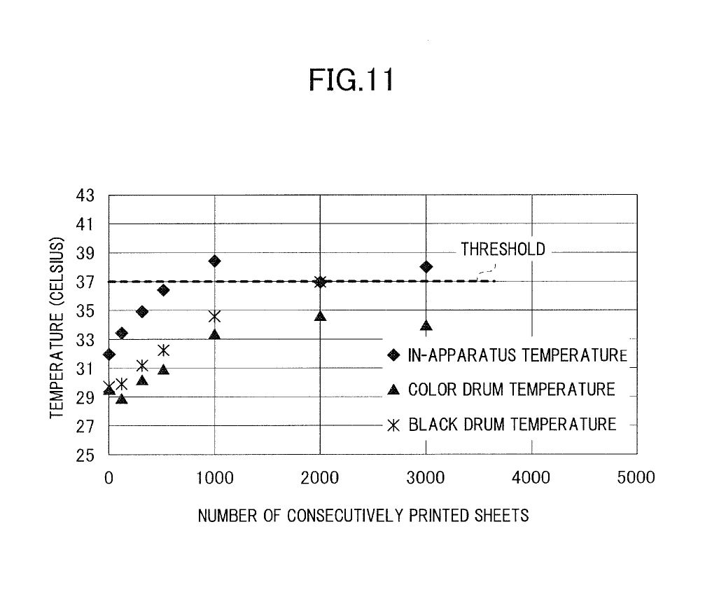

Here, setting of the conditions for executing the rotation process of the color photosensitive drums 1a, 1b and 1c in the monochrome mode will be described. FIG. 11 is a graph representing a relationship between a number of consecutively printed sheets and temperature within the apparatus in a duration of the monochrome mode. The in-apparatus temperature is temperature within a casing of the image forming apparatus 1 measured by the temperature and humidity sensor S1, and color and black drum temperatures are temperatures measured around the photosensitive drums 1a through 1d.

As indicated in the graph, the in-apparatus temperature and the color drum temperature increase along with an increase of the number of consecutively printed sheets within a range of 0 to 1,000 sheets and are almost constant within a range exceeding 1,000 sheets. Still further, when it was checked whether occurrence of toner sticking on the surface of the photosensitive drums 1a, 1b and 1c, it was confirmed that it is not necessary so much to consider toner sticking within a range of less than 2,000 sheets of consecutively printed sheets.

Then, in the present embodiment, the in-apparatus temperature of 37 degrees Celsius is set as a threshold, i.e., the predetermined temperature T1 is set 37 degrees Celsius, as a rough indication that the color photosensitive drums 1a, 1b and 1c have reached the roughly constant temperature range. Still further, because toner sticking occurs in a case where a certain period of time elapses in a condition in which the in-apparatus temperature is high, a threshold of number of consecutively printed sheets is set at 1,000 sheets, i.e., the predetermined number of sheets P1=1,000 sheets. However, it is preferable to appropriately change such threshold values corresponding to such characteristics as liability to an increase of the in-apparatus temperature and tendency to aggregate of the toner.

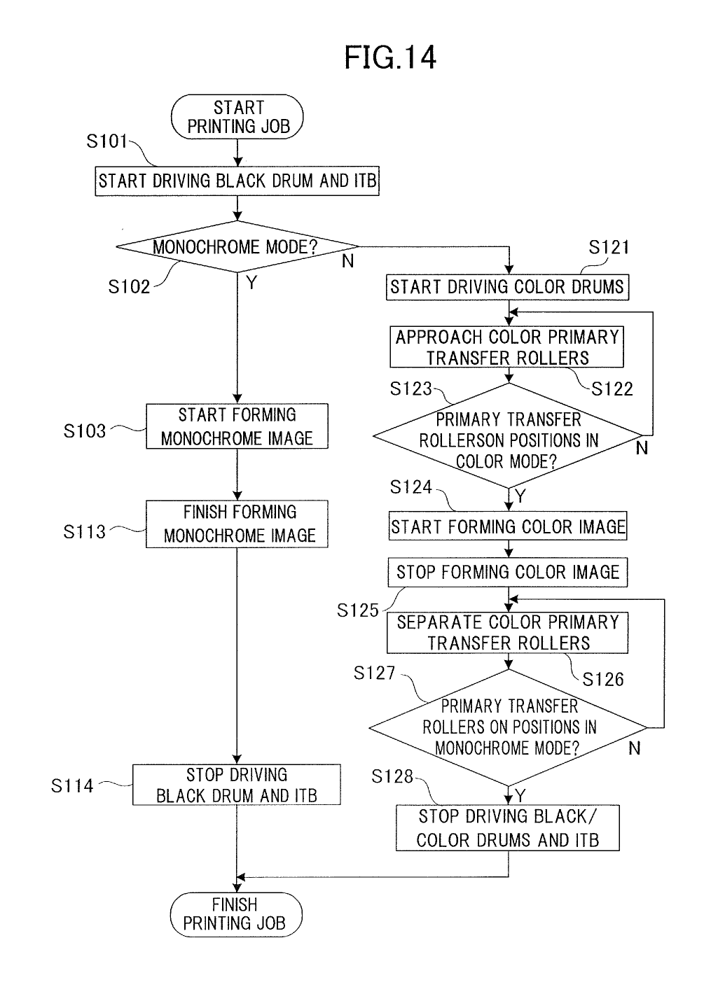

An advantages of the present embodiment will be described below by comparing with a comparative control process. As illustrated in FIG. 14, this comparative control process is different from the control process of the present embodiment in that the processes of the toner sticking avoiding mode, i.e., Steps S104 through S108 in FIG. 10, are not executed. Accordingly, when the output of images of the predetermined number of sheets is finished in Step S113, the CPU 101 stops the photosensitive drum 1d and the intermediate transfer belt 7 in Step S114 regardless of fluctuation of the in-apparatus temperature and other condition in the monochrome mode and finishes the printing job.

In such configuration as described above, however, if a printing job requesting output of more than 2,000 monochrome images is inputted, there is a possibility that toner sticking occurs on the color photosensitive drums 1a, 1b and 1c. Even if the printing job is that of less than 2,000 sheets, there is a possibility that toner sticking occurs if monochrome mode printing jobs are repeatedly inputted or if ambient temperature is high.

In contrast, according to the present embodiment, the operation of temporarily rotating the photosensitive drums 1a, 1b and 1c is executed as illustrated in Steps S107 and S108 in FIG. 10 in the case where consecutive printing of more than the predetermined number of sheets P1 is executed in the condition in which the in-apparatus temperature T exceeds the predetermined temperature T1. In other words, the rotation process is executed in the monochrome mode in a condition in which a detection result of the temperature and humidity sensor S1 exceeds the predetermined temperature during execution of the monochrome mode. Thereby, the possibility of causing toner sticking is reduced because the photosensitive drums 1a, 1b and 1c is relatively moved with respect to the cleaning blade 6a before the toner accumulated at the contact portion of the cleaning blade 6a is firmly stuck on the drum surface. That is, in addition to prolonging lives of the color photosensitive drums 1a, 1b and 1c by means of separating the color photosensitive drums 1a, 1b and 1c from the intermediate transfer belt 7 in the monochrome mode, it is possible to reduce the possibility of causing defective images otherwise caused by toner sticking.

It is noted that the present embodiment has been described such that the rotation of the photosensitive drums 1a, 1b and 1c is executed in the case where the temperature condition and the condition of the number of consecutively printed sheets are simultaneously met. That is, the present embodiment has been described such that the CPU 101 executes the rotation process of the photosensitive drums based on the detection result of the temperature and humidity sensor S1 and on the signals from the durability counter S3. It is noted that the CPU 101 may make such decision based on either one condition of the temperature and the number of consecutively printed sheets. For instance, it is conceivable to avoid toner sticking with such a configuration that the photosensitive drums 1a, 1b and 1c are rotated when the number of consecutively printed sheets in the monochrome mode becomes more than the predetermined number of sheets, e.g., more than 2,000 sheets. Still further, if readiness of causing toner sticking fluctuates due to wear of the photosensitive drums 1a, 1b and 1c, the condition of executing the rotation process may be changed based on a signal from the durability counter S3.

Still further, the arrangement of using the cleaning blade 6a that is arranged to abut against the photosensitive drum 1a from a counter direction of the rotation direction, i.e., an arrow R1 in FIG. 2, of the photosensitive drum 1a has been described as the cleaning member configured to clean the image bearing member in the present embodiment. However, toner sticking may occur even in a case where a blade member that is arranged to abut with the photosensitive drum from a trailing direction opposite from the counter direction and where a cleaning member of different shape and material other than the rubber blade is used. Accordingly, the technology of the present disclosure is also applicable to the case where such cleaning member is used.

### Second Embodiment

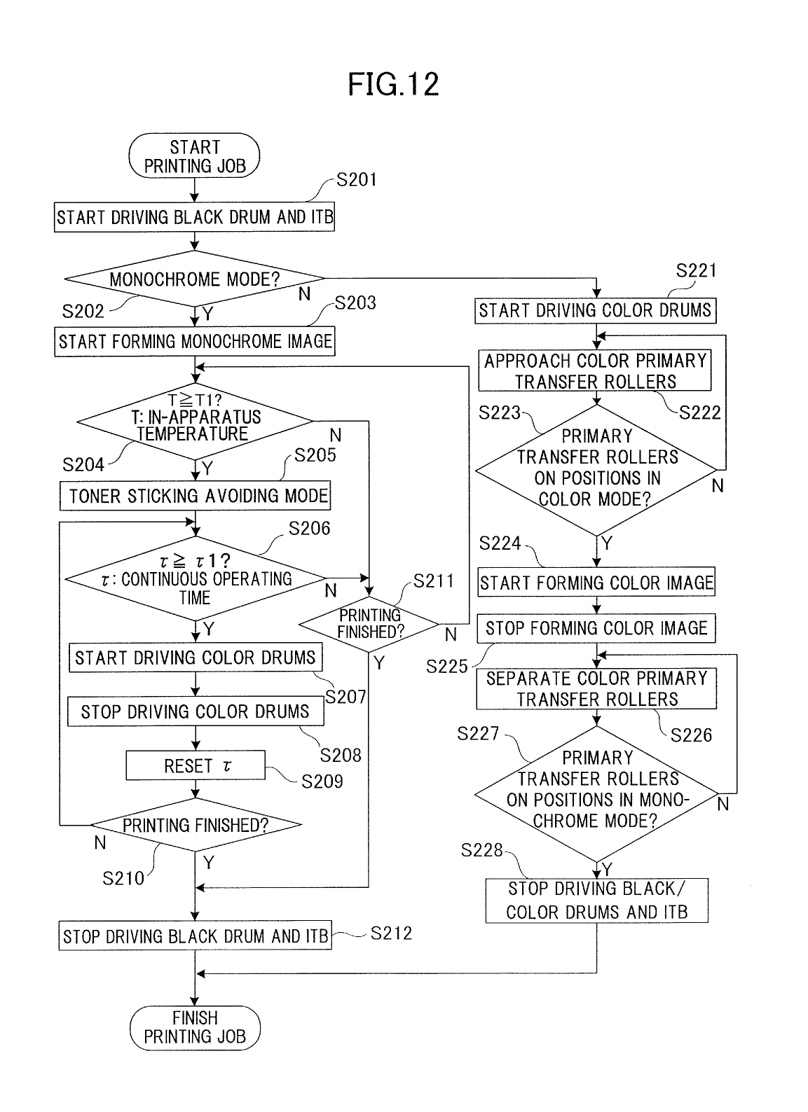

A control process of a second embodiment will be described next along a flowchart in FIG. 12. The present embodiment is different from the first embodiment in that a continuous operating time τ of the image forming portion 10 is adopted instead of the number of consecutively printed sheets.

In response to an input of a print job to the image forming apparatus 1, the CPU 101 starts to rotate the black photosensitive drum 1d and the intermediate transfer belt 7 in Step S201 and determines whether an image to be outputted is a color image or a monochrome image in Step S202.

### Monochrome Mode

The CPU 101 selects the monochrome mode in a case where the monochrome image is to be outputted, i.e., Y in Step S202, and starts to form a toner image in the black image forming unit Pd in Step S203. At this time, the color primary transfer rollers 5a, 5b and 5c are located at the separate positions, and the color photosensitive drums 1a, 1b and 1c are held in a condition in which their rotation is stopped. In the monochrome mode, while monitoring whether the in-apparatus temperature T detected by the temperature and humidity sensor S1 exceeds the predetermined temperature T1 in Step S204, the CPU 101 continues the printing job in Step S211.

In a case where the in-apparatus temperature T reaches a value equal to or more than the predetermined temperature T1, i.e., Y in Step S204, the CPU 101 shifts the mode to a toner sticking avoiding mode in Step S205 and judges whether the continuous operating time τ exceeds a predetermined time 11 in Step S206. Here, the continuous operating time τ is a time during which the image forming portion 10 operates after when the in-apparatus temperature T has reached the predetermined temperature T1 in the monochrome mode. The predetermined time τ1 is a value set as a rough indication of a time until when toner sticking occurs in the condition in which the in-apparatus temperature T exceeds the predetermined temperature T1 by taking aggregability of toner and other conditions into consideration. The predetermined time τ1 is set at 30 minutes for example. In a case where the continuous operating time τ is less than the predetermined time τ1, i.e., N in Step S206, the CPU 101 leaves from the toner sticking avoiding mode and continues the normal printing job.

In a case where the continuous operating time τ is more than the predetermined time τ1, i.e., Y in Step S206, the CPU 101 executes the process of temporarily rotating the color photosensitive drums 1a, 1b and 1c being in the stopped condition. That is, after an elapse of a predetermined period of time after driving the corresponding driving motor M3 in Step S207, the CPU 101 executes the process of stopping the rotation in Step S208. The driving time of the driving motor M3 in thus rotating the photosensitive drums 1a, 1b and 1c for the predetermined period of time is set at 60 msec, for example. In the case where the CPU 101 executes the rotation of the photosensitive drums 1a, 1b and 1c, the CPU 101 resets the value of the continuous operating time τ in Step S209 and continues the printing job in Step S210. Then, when the output of images of the number of sheets inputted as the printing job ends, i.e., Y in Step S210 and Y in Step S211, the CPU 101 stops rotation of the photosensitive drum 1d and the intermediate transfer belt 7 in Step S212 to finish the printing job.

### Color Mode

Meanwhile, in a case where the color image is to be outputted, i.e., N in Step S202, the CPU 101 starts to rotate the color photosensitive drums 1a, 1b and 1c in Step S221 and makes the primary transfer rollers 5a, 5b and 5c approach the corresponding photosensitive drums through the moving mechanism 40 in Step S222. When it is confirmed that the primary transfer rollers 5a, 5b and 5c have reached the contact positions, i.e., Y in Step S223, the respective image forming units Pa, Pb, Pc and Pd start to form toner images in Step S224.

When the output of the number of color image sheets inputted as the printing job is finished in Step S225, the CPU 101 moves the color primary transfer rollers 5a, 5b and 5c toward the separate positions in Step S226. Then, after confirming that the respective primary transfer rollers 5a through 5d are located at their home positions, i.e., Y in Step S227, the CPU 101 stops rotation of the photosensitive drums 1a through 1d and the intermediate transfer belt 7 in Step S228 to finish the printing job.

According to the present embodiment, the operation of temporarily rotating the photosensitive drums 1a, 1b and 1c is executed as illustrated in Steps S207 and S208 in FIG. 12 in the case where the time of more than the predetermined time τ1 has elapsed in the condition in which the in-apparatus temperature T exceeds the predetermined temperature T1. Accordingly, it is possible to reduce the possibility of causing toner sticking and to reduce the possibility of producing defective images in the same manner with the image forming apparatus 1 of the first embodiment.

It is noted that although the present embodiment has been described such that the rotation of the photosensitive drums 1a, 1b and 1c is executed in the case where the temperature condition and the condition of the continuous operating time are simultaneously met, the CPU 101 may execute the similar process by the sole condition of the continuous operating time. That is, it is conceivable to avoid toner sticking with such a configuration that the photosensitive drums 1a, 1b and 1c are rotated when an elapsed time from start of execution of the monochrome mode, i.e., the continuous operating time, becomes more than a predetermined time, e.g., more than 60 minutes.

### Third Embodiment

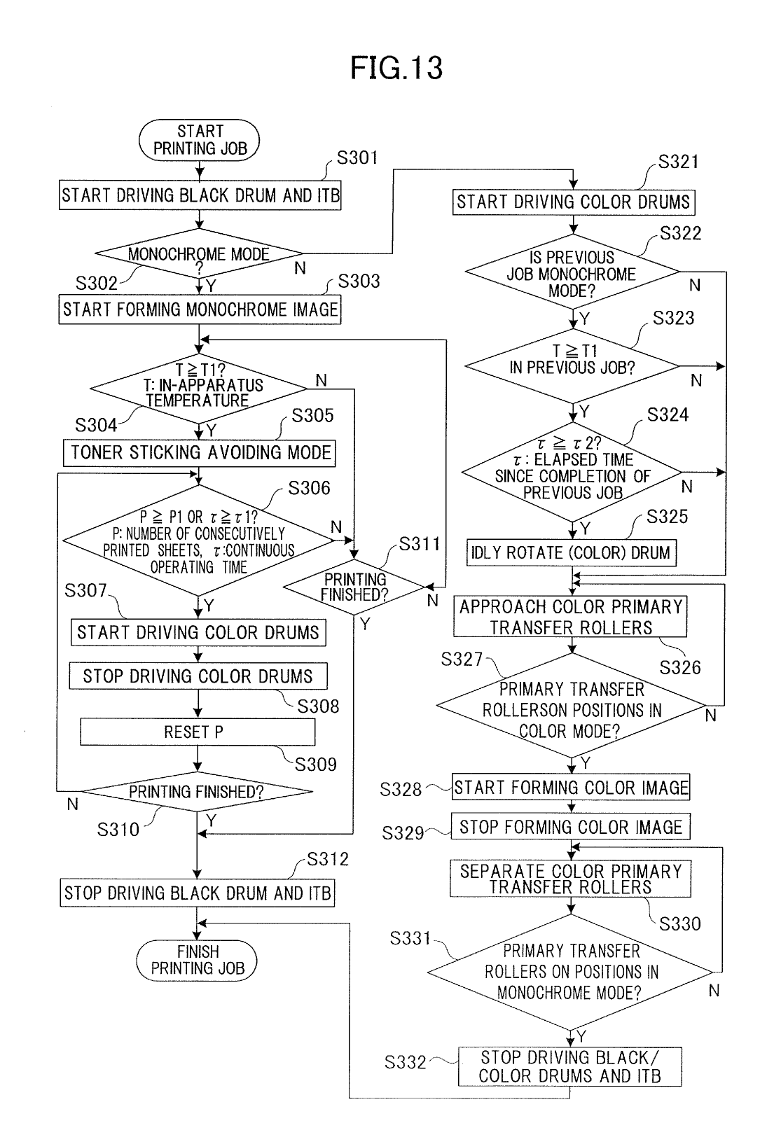

A control process of a third embodiment will be described next along a flowchart in FIG. 13. The present embodiment is different from the first and second embodiments described above in that a process for avoiding toner sticking is inserted, i.e., Step S325, is inserted before executing a succeeding printing job in a color mode when a predetermined condition is met in a duration of a preceding printing job in a monochrome mode.

In response to an input of a print job to the image forming apparatus 1, the CPU 101 starts to rotate the black photosensitive drum 1d and the intermediate transfer belt 7 in Step S301 and determines whether an image to be outputted is a color image or a monochrome image in Step S302.

### Monochrome Mode

The CPU 101 selects the monochrome mode in the case where the monochrome image is to be outputted, i.e., Y in Step S302, and starts to form a toner image in the black image forming unit Pd in Step S303. At this time, the color primary transfer rollers 5a, 5b and 5c are located at the separate positions, and the color photosensitive drums 1a, 1b and 1c are held in a condition in which their rotation is stopped. In the monochrome mode, while monitoring whether the in-apparatus temperature T detected by the temperature and humidity sensor S1 exceeds the predetermined temperature T1 in Step S304, the CPU 101 continues the printing job in Step S311.

In a case where the in-apparatus temperature T reaches a value equal to or more than the predetermined temperature T1, i.e., Y in Step S304, the CPU 101 shifts the mode to the toner sticking avoiding mode in Step S305 and judges whether the number of consecutively printed sheets P or the continuous operating time τ exceeds the predetermined threshold value, i.e., the predetermined number of sheets P1 or the predetermined time 11, in Step S306. Here, the number of consecutively printed sheets P, the continuous operating time τ and their threshold can be set in the same manner with the first and second embodiments described above. In a case where the number of consecutively printed sheets P and the continuous operating time τ are both less than the threshold values, i.e., N in Step S306, the CPU 101 leaves from the toner sticking avoiding mode and continues the normal printing job.

In a case where the number of consecutively printed sheets P or the continuous operating time τ is more than the threshold value, i.e., Y in Step S306, the CPU 101 executes the process of temporarily rotating the color photosensitive drums 1a, 1b and 1c. That is, after driving the corresponding driving motor M3 for a certain period of time τn Step S307, the CPU 101 executes the process of stopping the rotation in Step S308. The driving time of the driving motor M3 is set at 60 msec, for example. In the case where the CPU 101 executes the rotation of the photosensitive drums 1a, 1b and 1c, the CPU 101 resets the value of the number of consecutively printed sheets P in Step S309 and continues the printing job in Step S310. Then, when the output of images of the number of sheets inputted as the printing job ends, i.e., Y in Step S310 and Y in Step S311, the CPU 101 stops rotation of the photosensitive drum 1d and the intermediate transfer belt 7 in Step S312 to finish the printing job.

### Color Mode

Meanwhile, in a case where the color image is to be outputted, i.e., N in Step S302, the CPU 101 starts to rotate the color photosensitive drums 1a, 1b and 1c in Step S321. Here, the CPU 101 determines whether a potential occurrence of toner sticking in a duration of a standby period by making reference to information in the previous printing job. That is, the CPU 101 determines whether the previous printing job has been executed in the monochrome mode in Step S322, whether the in-apparatus temperature has exceeded the predetermined temperature T1 in Step S323, and whether a predetermined standby time τ2 has elapsed from completion of the previous job to the input of the present job in Step S324.

Then, in a case where these conditions are all met, the CPU 101 idly rotates the color photosensitive drums 1a, 1b and 1c for a certain period of time τn Step S325 before moving the primary transfer rollers 5a, 5b and 5c to the contact positions. The period during which the photosensitive drums 1a, 1b and 1c are idly rotated is set such that stuck toner or nearly toner in a state close to stuck can be fully removed by the cleaning blade 6a. At least such period is set to be longer than a period of idly rotating the drums in a case where the abovementioned conditions are not met.

After that, the CPU 101 makes the primary transfer rollers 5a, 5b and 5c approach the corresponding photosensitive drums through the moving mechanism 40 in Step S326. When it is confirmed that the primary transfer rollers 5a, 5b and 5c have reached the contact positions, i.e., Y in Step S327, the respective image forming units Pa, Pb, Pc and Pd start to form toner images in Step S328.

When the output of the number of color image sheets inputted as the printing job is finished in Step S329, the CPU 101 moves the color primary transfer rollers 5a, 5b and 5c toward the separate positions in Step S330. Then, after confirming that the respective primary transfer rollers 5a through 5d are located at their home positions, i.e., Y in Step S331, the CPU 101 stops rotation of the photosensitive drums 1a through 1d and the intermediate transfer belt 7 in Step S332 to finish the printing job.

According to the present embodiment, the operation of temporarily rotating the photosensitive drums 1a, 1b and 1c is executed as illustrated in Steps S307 and S308 in FIG. 13 in the case where the number of images more than the predetermined number of sheets P1 has been outputted or the time of more than the predetermined time τ1 has elapsed in the condition in which the in-apparatus temperature T exceeds the predetermined temperature T1. Accordingly, it is possible to reduce the possibility of occurrence of toner sticking and to reduce the possibility of producing defective images in the same manner with the image forming apparatus 1 of the first and second embodiments.

In addition to that, the CPU 101 executes idling of the photosensitive drums 1a, 1b and 1c in Step S325 when a certain condition is met in a case where the printing job is to be executed in the color mode after the monochrome mode in the present embodiment. This configuration makes it possible to remove or reduce adhesive materials by the cleaning blade 6a by the idling operation even if toner is stuck or becomes close to a stuck condition in a duration of a standby period. Thereby, the possibility of causing toner sticking may be reduced further.

While the arrangement in which the belt member is used as the intermediate transfer member has been described in the first through third embodiments, such arrangement may be replaced by an arrangement in which an intermediate transfer member of a drum member, for example, is used as long as the image bearing member on which the toner image is primarily formed can be made into contact with/separate from the intermediate transfer member on which the toner image is to be transferred. Still further, although the abovementioned embodiments have been described such that the monochrome image is formed in the first mode and the color image is formed in the second mode, another operation may be carried out the first and second modes. For instance, the first mode may be a mode of outputting a glossy image by using transparent toner in addition to colored toner, and the second mode may be a mode of outputting an image without using the transparent toner.

Still further, while the moving mechanism 40 capable of collectively switching the contact positions between the color photosensitive drums 1a, 1b and 1c and the intermediate transfer belt 7 has been described as one exemplary switch mechanism in the above embodiments, a switch mechanism configured to bring an individual photosensitive drum into contact with/separate from the intermediate transfer belt may be used. Still further, in a case where a part of the image bearing members is switched to be used/not to be used depending on modes of image forming operations, the switch mechanism may be what switches the contact/separate conditions of, at least, such part of the image bearing members with respect to the intermediate transfer member.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-152177, filed on Aug. 2, 2016, which is hereby incorporated by reference wherein in its entirety.

What is claimed is:

1. An image forming apparatus comprising:
a first image bearing member configured to rotate while bearing a toner image;
a second image bearing member configured to rotate while bearing a toner image;
an endless intermediate transfer member configured to bear and convey a toner image transferred from either or both of the first and second image bearing members and to be transferred to a recording medium at a transfer portion;
a switch mechanism configured to switch between a state in which the second image bearing member is in contact with the intermediate transfer member and a state in which the second image bearing member is separated from the intermediate transfer member;
a cleaning member disposed in contact with the second image bearing member and configured to clean a surface of the second image bearing member along with rotation of the second image bearing member;
a temperature detecting portion configured to detect temperature; and
a control portion configured to execute an either mode of a first mode and a second mode, the first mode being a mode in which toner images are formed on the first and second image bearing members and are transferred to the intermediate transfer member so as to form an image on the recording medium in a state where the first and second image bearing members are in contact with the intermediate transfer member, the second mode being a mode in which a toner image is formed on the first image bearing member and is transferred to the intermediate transfer member so as to form an image on the recording medium in a state where the first image bearing member is in contact with the intermediate transfer member and the second image bearing member is separated from the intermediate transfer member, the control portion being configured to execute a rotation process in which rotation of the second image bearing member being in a stopped condition is started and then is stopped in a duration of the second mode in a case where detection result of the temperature detecting portion exceeds a predetermined temperature in the duration of the second mode.

2. The image forming apparatus according to claim 1, wherein the control portion is configured to execute the rotation process if a number of recording media that have been outputted in a condition in which detection result of the temperature detecting portion exceeds the predetermined temperature exceeds a predetermined number of sheets in the duration of the second mode.

3. The image forming apparatus according to claim 1, wherein the control portion is configured to execute the rotation process if a predetermined time has elapsed in a condition in which detection result of the temperature detecting portion exceeds the predetermined temperature in the duration of the second mode.

4. The image forming apparatus according to claim 1, wherein the control portion is configured to execute the rotation process if the control portion detects that a number of recording media that have been outputted in a condition in which detection result of the temperature detecting portion exceeds the predetermined temperature exceeds a predetermined number of sheets in the duration of the second mode, or that a predetermined time has elapsed in a condition in which detection result of the temperature detecting portion exceeds the predetermined temperature in the duration of the second mode.

5. The image forming apparatus according to claim 1, wherein the control portion is configured such that, if detection result of the temperature detecting portion exceeds the predetermined temperature in the duration of the second mode and if a predetermined standby time has elapsed since an end of the second mode, the control portion executes an operation of rotating the second image bearing member in a state being separated from the intermediate transfer member.

6. The image forming apparatus according to claim 1, wherein the control portion is configured such that, if detection result of the temperature detecting portion exceeds the predetermined temperature in the duration of the second mode and if the control portion executes the first mode after the second mode has been finished, the control portion executes an operation of rotating the second image bearing member before the second image bearing member is brought into contact with the intermediate transfer member by the switch mechanism in order to start the first mode.

7. The image forming apparatus according to claim 1, wherein a rotation amount of the second image bearing member in the rotation process is less than one rotation.

8. The image forming apparatus according to claim 1, further comprising:
a first transfer member configured to transfer a toner image borne on the first image bearing member to the intermediate transfer member; and
a second transfer member configured to transfer a toner image borne on the second image bearing member to the intermediate transfer member,
wherein the intermediate transfer member is an endless belt member, and the first and second transfer members are disposed on an inner circumferential side of the belt member, and
wherein the switch mechanism is configured to switch contact and separation between the second transfer member and the intermediate transfer member by moving the second transfer member between a contact position where the second transfer member is in contact with the second image bearing member across the intermediate transfer member and a separate position where the second transfer member is separated from the second image bearing member.

9. The image forming apparatus according to claim 8,
wherein the switch mechanism comprises
a driving motor controlled by the control portion,
a cam member rotated by the driving motor,
a first actuation portion actuated by the cam member and configured to bring the first transfer member to abut with and separate from the first image bearing member, and
a second actuation portion actuated by the cam member and configured to bring the second transfer member to abut with and separate from the second image bearing member, and
wherein the cam member is configured such that the first and second transfer members are moved separately in accordance with a rotation phase of the cam member.

10. The image forming apparatus according to claim 1, wherein the control portion is configured such that a color image is formed on the recording medium in the first mode and a monochrome image is formed on the recording medium in the second mode.
